(19) United States
(12) Patent Application Publication
(10) Pub. No.: US 2009/0215470 A1
(43) Pub. Date: Aug. 27, 2009

(54) METHOD, APPARATUS OR SOFTWARE FOR LOCATING A MOBILE NODE RELATIVE TO ONE OR MORE OTHER NODES

(75) Inventors: Helen Samantha Bowyer, Hampshire (GB); Timothy Peter Griffith, Hampshire (GB); Andrew Taylor, Winchester (GB)

Correspondence Address: Steven E. Bach Attorney at Law, 10 Roberts Road, Newtown Square, PA, 19073, US

(73) Assignee: International Business Machines Corporation, Armonk, NY (US)

(21) Appl. No.: 12/393,734

(22) Filed: Feb. 26, 2009

(30) Foreign Application Priority Data
Feb. 27, 2008 (EP) 08151997.7

(51) Int. Cl. H04W 24/00; H04W 4/00

(52) U.S. Cl. 455/456.3; 370/328

(57) ABSTRACT

A method, apparatus and software is disclosed in which the location of a mobile device is calculated from the signal coverage areas of other detected nodes.

### FIELD OF INVENTION

The present invention relates to a method, apparatus or software for locating a mobile node relative to one or more other nodes.

### BACKGROUND OF THE INVENTION

Positioning or locating systems for determining the position of a device have a large number of applications across many industries. One commonly used positioning system is the Global Positioning System (GPS). One problem with GPS is that it requires specialized equipment and its function may be degraded in enclosed spaces such as the interior of buildings. Other positioning systems exist which use the signals of existing wireless systems, commonly used for communications, to determine the position of a device. In such systems, the device is arranged to triangulate its position from the measured signal strengths of three or more other devices having known positions. One problem with such triangulation systems is that at least three signals are usually required for triangulation. Furthermore, the triangulation process requires significant processing resources from the device.

### SUMMARY OF THE INVENTION

An embodiment of the invention provides a method for locating a mobile node relative to one or more other nodes, the method comprising the steps of:
a) receiving data indicating the detection at a first node of signals transmitted from one or more second nodes, each second node having a known location;
b) determining the signal coverage area of each detected second node;
c) identifying one or more third nodes, from which no signal is detected at the first node, each having a known location and each having a signal coverage area coincident with the signal coverage area of one or more of the detected second nodes;
d) determining a plausible area for the location of the first node from the combination of the signal coverage areas for each detected second node and the exclusion of the signal coverage areas of each identified third node; and
e) calculating the center of the plausible area and locating the first node at the center.

The center may be the center of mass of the plausible area. The center may be the geometric centre of the plausible area. Prior to the determination of the plausible area, the signal coverage area of each detected second node may be increased by a position certainty factor where the position certainty factor has a magnitude that reduces in proportion to the time elapsed since the determination of the location of the respective second node. Prior to the determination of the plausible area, the signal coverage area of each identified third node may be reduced by a position certainty factor where the position certainty factor has a magnitude that reduces in proportion to the time elapsed since the determination of the location of the respective third node.

The position certainty factor may be selected so as to modify the respective signal coverage area in proportion to the expected movement rate of a respective node. The method may comprise the further step of assigning an initial position certainty factor to the first node when the first node is located. The initial position certainty factor may be based on the respective position certainty factors of the detected second nodes. The position certainty factor may be set to a predetermined value. Any given node having a fixed known location may have a fixed position certainty factor. Each signal coverage area may define a three dimensional space and the location of the first node may be performed in three dimensions. The location of the center may be transmitted to the first node. Data may be selected and transmitted to the first node in dependence on the location of the center.

Another embodiment provides an apparatus for locating a mobile node relative to one or more other nodes, the apparatus being operable to: receive data indicating the detection at a first node of signals transmitted from one or more second nodes, each second node having a known location; determine the signal coverage area of each detected second node; identify one or more third nodes, from which the first node receives no signal, each having a known location and each having a signal coverage area coincident with the signal coverage area of one or more of the detected second nodes; determine a plausible area for the location of the first node from the combination of the signal coverage areas for each detected second node and the exclusion of the signal coverage areas of each identified third node; and calculate the center of the plausible area and locating the first node at the center.

A further embodiment provides a group of one or more programs arranged to enable a group of one or more programmable devices to perform a method for locating a mobile node relative to one or more other nodes, the method comprising the steps of:
a) receiving data indicating the detection at a first node of signals transmitted from one or more second nodes, each second node having a known location;
b) determining the signal coverage area of each detected second node;
c) identifying one or more third nodes, from which no signal is received at the first node, each having a known location and each having a signal coverage area coincident with the signal coverage area of one or more of the detected second nodes;
d) determining a plausible area for the location of the first node from the combination of the signal coverage areas for each detected second node and the exclusion of the signal coverage areas of each identified third node; and
e) calculating the center of the plausible area and locating the first node at the center.

Another embodiment provides a group of one or more programs arranged to enable a group of one or more programmable devices to provide apparatus for locating a mobile node relative to one or more other nodes, the apparatus being operable to: receive data indicating the detection at a first node of signals transmitted from one or more second nodes, each second node having a known location; determine the signal coverage area of each detected second node; identify one or more third nodes, from which the first node receives no signal, each having a known location and each having a signal coverage area coincident with the signal coverage area of one or more of the detected second nodes; determine a plausible area for the location of the first node from the combination of the signal coverage areas for each detected second node and the exclusion of the signal coverage areas of each identified third node; and calculate the center of the plausible area and locating the first node at the center.

### BRIEF DESCRIPTION OF THE DRAWINGS

Embodiments of the invention will now be described, by way of example only, with reference to the accompanying drawings in which:

FIG. 1 is a schematic illustration of a mobile device location system according to a sample embodiment of the present invention;

FIGS. 2 to 6 are schematic illustrations of the process of locating of a mobile node in the system of FIG. 1 according to a sample embodiment of the present invention;

FIG. 7 is a table illustrating data relating to nodes stored in the system of FIG. 1 according to a sample embodiment of the present invention;

FIG. 8 is a flow chart illustrating processing performed by a client application program on a mobile node in the system of FIG. 1 according to a sample embodiment of the present invention; and

FIGS. 9 and 10 are flow charts illustrating processing performed by a server application program in the system of FIG. 1 according to a sample embodiment of the present invention.

### DETAILED DESCRIPTION OF PREFERRED EMBODIMENTS OF THE INVENTION

With reference to FIG. 1, a mobile device location system 101 comprises a first mobile device 102 and a set of second and third mobile devices 103, 104, 105 within a predetermined area 106. Each of the mobile devices 102, 103, 104, 105 is equipped with a first communications system in the form of a short range radio communications protocol such as Bluetooth™. Two Bluetooth™ base stations 107, 108 are provided within the area 106 and have known fixed positions. The mobile devices 102, 103, 104, 105 and the base stations 107, 108, herein also referred to as nodes, each emit Bluetooth™ signals over a predetermined signal coverage area. Each node is also arranged to detect the signals of other nodes when within the signal coverage area of another node and to identify the other node from the detected signal.

Each of the mobile devices 102, 103, 104, 105 is equipped with a long range wireless communications system in the form of a General Packet Radio Service (GPRS) data link 109 which provides a communications link via a mobile telephone system 110 and a wide area network (WAN) 111 to a computer 112. The base stations 107, 108 are also connect to the computer 112 by a local area network (LAN) 113. The computer 112 is also connected to a storage device 114. Each of the nodes 102, 103, 104, 105 107, 108 are loaded with a device location client application program (not shown) and the computer 112 is loaded with a device location server application program (not shown). The device location client application program on a given node is arranged to periodically identify the detected Bluetooth™ signals of any of the other nodes. In other words, the device location client is arranged to identify nodes whose signal coverage area the given node is located within. The detected node is identified via a node identifier transmitted within the Bluetooth™ signal. In the present embodiment, the device location client is arranged to transmit the identifiers for the detected nodes to the device location server 112. The device location server 112 is arranged to calculate a location for a given device based on the other nodes that the given device reports as being able to detect. The device location server 112 is arranged to transmit the calculated location back to the given device. Once a given device receives its location from the device location server 112, the device is able to provide the location data and related services to its user. The algorithm used by the device location server 112 to calculate the location of a given device is described in further detail below.

FIG. 2 is an illustration of the signal coverage areas of each of the second and third mobile devices 103, 104, 105 and the base stations 107, 108. The known locations of the nodes are indicated by a dot at the centers of their respective signal coverage areas 201, 202, 203, 204, 205. In the present example, the location of the first mobile device 102 is unknown and is thus indicated with a dotted outline. However, the first mobile device 102 reports to the device location server 112 the detection of signals from two of the second devices 103, 105 as a result of being within the respective signal coverage areas 201, 204. The combined signal coverage areas 201, 204 of the detected nodes form the basis of the calculation by the device location server 112 of the location of the first mobile device 102. In other words, the combined signal coverage areas 201, 204 form a first plausible area within which the first mobile node is likely to be located.

However, positions of the detected nodes 103, 105 and consequently their respective signal coverage areas 201, 204 may have changed since their respective positions were calculated by the device location server 112. Thus, in the present embodiment, the device location server 112 is arranged to take into account the possible movement of mobile nodes between the time at which their position was last calculated and the time at which that position is used to calculate the position of another node. The device location server 112 assigns a position certainty factor (PCF) to each newly calculated position. According to a sample embodiment, the PCF is a percentage value and is arranged to decay to zero over a predetermine time period of 5 seconds. The PCF thus provides an indication of the accuracy of the position of a given mobile node. In the present embodiment, the initial PCF assigned to a given node is an average of the PCFs of the nodes from which the location of the given node was calculated. Fixed nodes have fixed PCF of 1.0 (100%) that does not decay over time. The device location server is arranged to increase the signal coverage areas 201, 204 by the PCFs for the respective nodes 103, 105. This results in expanded signal coverage areas 301, 302 as shown in FIG. 3. The increase of the signal coverage areas of detected nodes is based on the assumption that if a node has been detected then it is assumed to have moved in the general direction of the detecting node, that is, the first node 102.

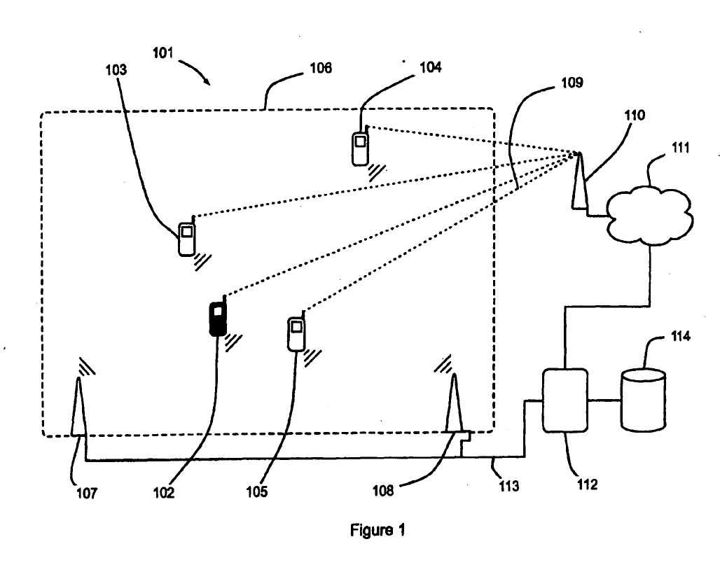

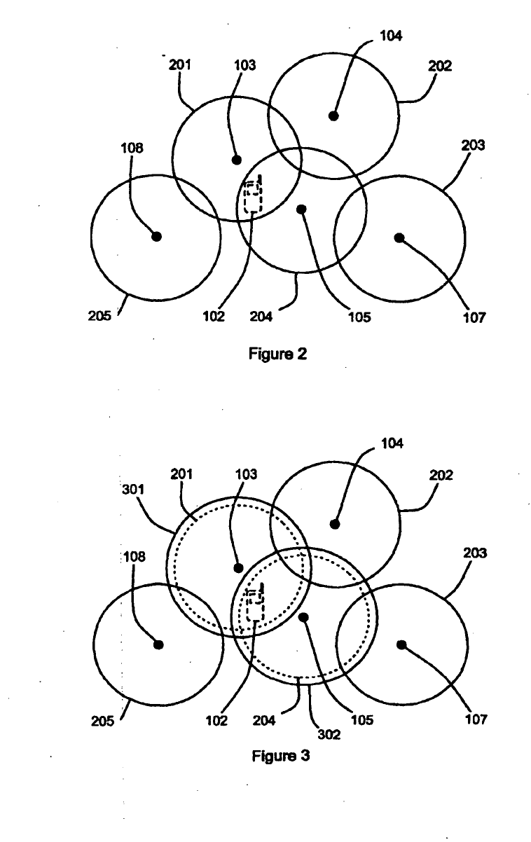

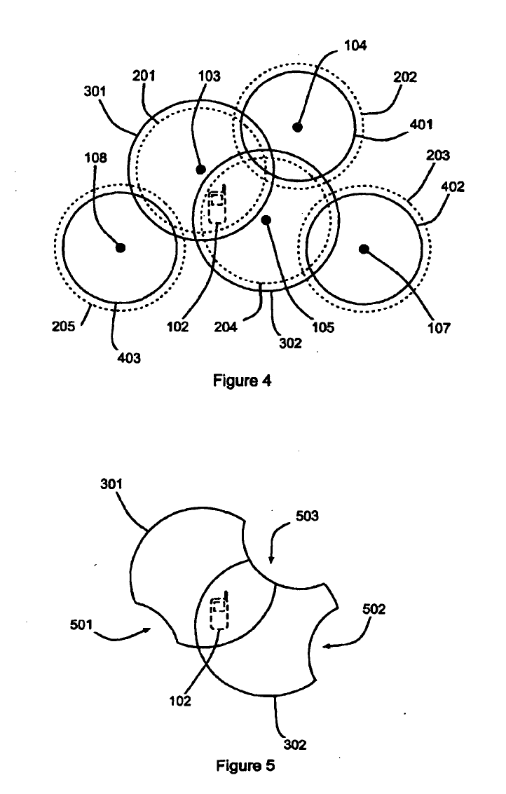

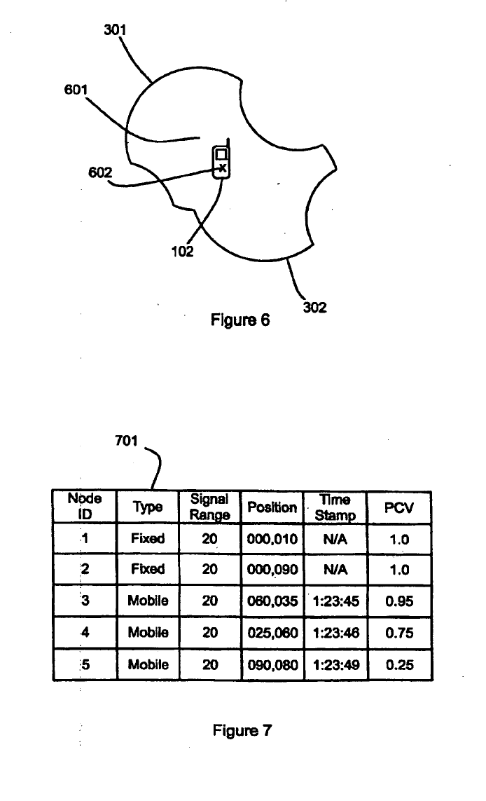

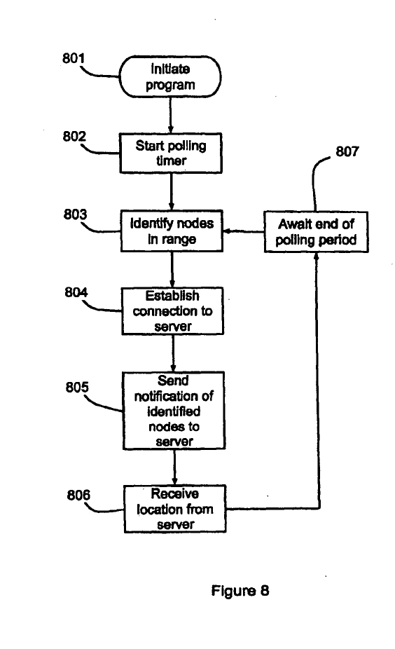

The device location server is further arranged to identify the signal coverage areas of third nodes that have not been detected by the first node but whose signal coverage areas impinge on those of the detected nodes. In the present example, the signal coverage area 202 of the remaining mobile node 104 and the signal coverage areas 203, 205 of the fixed nodes 107, 108 each impinge on the expanded combined signal coverage areas 301, 302 of the detected nodes 103, 105. In the present embodiment, the impinging signal coverage areas 202, 203, 205 are reduced by the PCFs for the respective nodes 103, 105. This results in reduced signal coverage areas 401, 402, 403 as shown in FIG. 4. The reduction of the signal coverage areas of non-detected but impinging nodes is based on the assumption that if a node has not been detected then it is assumed to have moved in a general direction away from the detecting node, that is, the first node 102.

With reference to FIG. 5, having determined the revised signal coverage areas 301, 302, 401, 402, 403 to account for possible movement of mobile nodes, the device location server is arranged to remove the impinging areas 501, 502, 503 of the reduced signal coverage areas 401, 402, 403 from the expanded combined signal areas 301, 302. The resulting combined signal areas 301, 302 comprise a second plausible area 601 within which the first mobile device 102 is most likely to be located. The location of the center of mass 602 of the plausible area 601 is then calculated and assigned as the position of the first mobile device 102.

With reference to FIG. 7, the device location server 112 is arranged to keep a record 701 of data for each node that has been positioned in the system. For each node, a unique identifier for the node is stored along with the type of the node, that is, whether the node has a fixed position or is a mobile node. In addition, the signal range of the node is logged. The position of a given node is also recorded, with the location of fixed nodes being input manually and the position of mobile nodes calculated as described above. Each fixed node is assigned a fixed PCF of 1.0 as described above. Each mobile node is assigned a PCF, based on the combined PCFs of the other nodes from which its position was calculated, along with a timestamp for that position calculation.

The processing performed by the device location client application program running on the first device 102 will now be described further with reference to the flow chart of FIG. 8. At step 801, processing is initiated in the present embodiment when the mobile device is switched on. Processing then moves to step 802 where a 5 second polling timer is set and processing moves to step 803. At step 803, the Bluetooth™ system is used to scan for any detectable nodes and the unique identifiers of any such nodes are logged. Processing then moves to step 804 where a connection to the device location server 112 is established and processing moves to step 805. At step 805, a notification of the detected nodes is sent to the server and processing moves to step 806 to await a response. When, a response is received from the server the supplied location data is made available to the systems on the mobile device that requires it and processing moves to step 807 to await the end of the polling period at which point processing returns to step 803 and proceeds as described above.

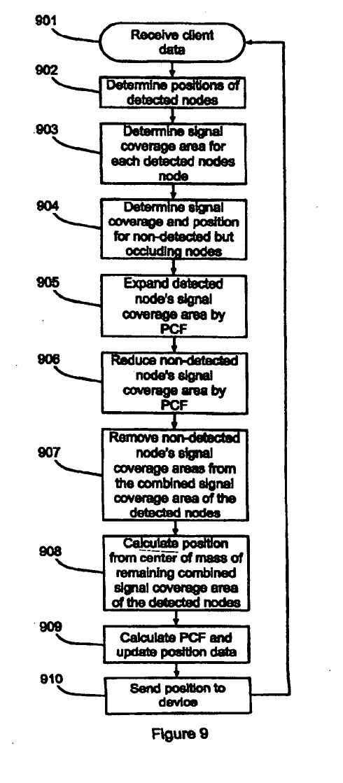

The processing performed by the device location server application program running on the computer 112 when calculating the position of a mobile device will now be described further with reference to the flow chart of FIG. 9. At step 901, processing is initiated in response to the receipt of data from a device location client application program and processing moves to step 902. At step 902, the last calculated or fixed positions of the detected nodes are identified from the position data 701 and processing moves to step 903. At step 903, the signal coverage area is calculated for each detected node and processing moves to step 904. At step 904, any impinging but non-detected nodes are identified and their positions and signal coverage areas determined from the position data 701. Processing then moves to step 905 where the signal coverage area for each detected node is increased by the PCF for the given node taking into account the time elapsed as determined by the time stamp from the position data 701. Processing then moves to step 906 where the signal coverage area for each impinging but non-detected node is reduced in accordance with the PCF for the given node and the time elapsed as determined by the time stamp from the position data 701. Processing then moves to step 907 where the impinging sections of the non-detected nodes' reduced signal coverage areas are removed from the combined increased signal coverage area of the detected nodes leaving the second plausible area for the location of the mobile node. Processing then moves to step 908 where the center of mass for the second plausible volume is calculated and assigned as the location for mobile device. Processing then moves to step 909 where the PCF is calculated for the newly calculated position and updated for the mobile device in the position data 701 along with the newly calculated position and an appropriate time stamp. Processing then moves to step 910 where the newly calculated position is supplied to the requesting mobile device. Processing then returns to step 901 to await a further location request from a client application program.

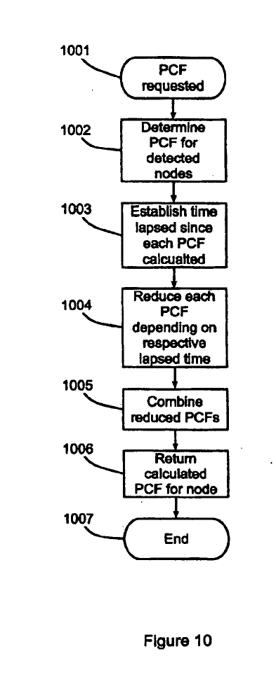

The processing performed by the device location server application program running on the computer 112 when calculating the PCF for a located mobile device will now be described further with reference to the flow chart of FIG. 10. At step 1001, processing is initiated in response to the processing at step 909 in FIG. 9. Processing then moves to step 1002 where the PCF for each detected node is determined from the position data 701 and processing moves to step 1003. At step 1003, the time elapsed for each PCF is calculated from the respective time stamp and processing moves to step 1004. At step 1004, each PCF is reduced in accordance with the respective elapsed time and processing moves to step 1005. At step 1005, the reduced PCFs are combined in accordance with a predetermined formula to produce a new PCF for the newly calculated position and processing moves to step 1006. At step 1006, the new PCF is stored and is returned to the requesting process in step 909 of FIG. 9. Processing then moves to step 1007 and ends.

In another embodiment, the PCF is arranged to reduce or decay with respect to time but set to 1.0 (100%) each time a new position for a given node is calculated. In other words, the PCF for a new position takes no account of the PCFs of the nodes from which the new position is calculated. As will be understood by those skilled in the art, the decay period for the PCF can be set to any suitable value for a given application.

In a further embodiment, the calculation of the PCF for a new position is skewed to give full account of the contribution towards positioning of the PCF of a fixed node. In another embodiment, the PCF is not applied to impinging but non-detected nodes. In further embodiment, the PCF is not applied to detected nodes. In another embodiment, the PCF is arranged to scale a dimension, such as the diameter or radius, of a signal coverage area by an expected or averaged travel speed for a given node or a group of nodes. For example, if a node travels at 1 m/s, the radius of a detected node is increased by 1 m for each second of elapsed time since the calculation of the position of that node. In a further embodiment, the PCF mechanism is omitted and thus the signal coverage areas of detected or non-detected but impinging nodes remain constant. In another embodiment, the position data for a node is effectively removed from the table 701 after a predetermined period.

In a further embodiment, the location of nodes is performed within a three dimensional (3D) space where the signal coverage areas are volumes and a three dimensional coordinate system used to locate nodes. As will be understood by those in the art, a 3D system may take in to account physical features when locating a given node such as assuming all nodes will be located on a floor within multi floor building.

As will be understood by those skilled in the art, the wireless connections between the nodes and the location server may be provided by any suitable protocol such as the Wireless Fidelity protocol (WiFi) and the nodes may form any suitable form of network such as Pier-to-Pier (P2P) network, which may be a Piconet or Scatternet. The connection to the server and the detection of neighbouring nodes as described above may be performed by the same or different protocols or network arrangements. The system may not contain any fixed nodes, with all positions being determined as relative positions between mobile nodes or relative to an initial fixed or reference position propagated though the network.

In another embodiment, the processing performed by the device location server is instead distributed over the nodes in the network arranged as, for example, a P2P network. Thus, the nodes in the network are arranged to distribute position data from surrounding nodes and to calculate their own respective locations.

As will be understood by those in the art, the initiation of the device location client application program on a given device may be arranged to occur automatically, for example on entry into the area 106 or manually. Alternatively, a user may be prompted to join the system 101 on entry into the area 106. The position data may be used by a given node in combination with node-based data or to send location-based data to a given device. For example, the location data may be used to offer directions to a location requested by the user.

As will be understood by those in the art, the center of mass of the plausible area or volume may be determined by any suitable technique. For example, the center of mass may be deemed to be the geometric center of the plausible area or volume.

It will be understood by those skilled in the art that the apparatus that embodies a part or all of the present invention may be a general purpose device having software arranged to provide a part or all of an embodiment of the invention. The device could be a single device or a group of devices and the software could be a single program or a set of programs. Furthermore, any or all of the software used to implement the invention can be communicated via any suitable transmission or storage means so that the software can be loaded onto one or more devices. The software can be encoded on a program product comprising storage means such as a disc, a hard drive, an optical scanning device, or the like.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A method for locating a mobile node relative to one or more other nodes, said method comprising the steps of:
receiving data indicating the detection at a first node of signals transmitted from one or more second nodes, each said second node having a known location;
determining the signal coverage area of each detected second node;
identifying one or more third nodes from which no signal is received at the first node, each having a known location and each having a signal coverage area coincident with said signal coverage area of one or more of said detected second nodes;
determining a plausible area for the location of said first node from the combination of the signal coverage areas for each detected second node and the exclusion of the signal coverage areas of each identified third node; and
calculating the center of said plausible area and locating said first node at said center.

2. The method according to claim 1 in which said center is the centre of mass of said plausible area.

3. The method according to claim 1 in which said center is the geometric centre of said plausible area.

4. The method according to claim 1, wherein, prior to the determination of said plausible area, the signal coverage area of each detected second node is increased by a position certainty factor where said position certainty factor has a magnitude that reduces in proportion to the time elapsed since the determination of the location of said respective second node.

5. The method according to claim 4, wherein, prior to the determination of said plausible area, the signal coverage area of each identified third node is reduced by a position certainty factor where said position certainty factor has a magnitude that reduces in proportion to the time elapsed since the determination of the location of said respective third node.

6. The method according to claim 4, wherein said position certainty factor is selected so as to modify the respective signal coverage area in proportion to the expected movement rate of a respective node.

7. The method according to claim 4, wherein said method comprises the further step of assigning an initial position certainty factor to said first node when said first node is located.

8. The method according to claim 7, wherein said initial position certainty factor is based on the respective position certainty factors of said detected second nodes.

9. The method according to claim 7, wherein said position certainty factor is set to a predetermined value.

10. The method according to claim 4, wherein at least one node has a fixed known location and each node having a fixed known location has a fixed position certainty factor.

11. The method according claim 1, wherein each said signal coverage area defines a three dimensional space and said location of said first node is performed in three dimensions.

12. The method according to claim 1, wherein the location of said center is transmitted to said first node.

13. The method according claim 1, wherein data is selected and transmitted to said first node in dependence on the location of said center.

14. An apparatus for locating a mobile node relative to one or more other nodes, said apparatus comprising:
means for receive data indicating the detection at a first node of signals transmitted from one or more second nodes, each said second node having a known location;
means for determine the signal coverage area of each detected second node;
means for identify one or more third nodes each having a known location and each having a signal coverage area coincident with said signal coverage area of one or more of said detected second nodes;
means for determine a plausible area for the location of said first node from the combination of the signal coverage areas for each detected second node and the exclusion of the signal coverage areas of each identified third node; and
means for calculate the center of said plausible area and transforming a location memory to locating said first node at said center.

15. The apparatus according to claim 14, further comprising means for, prior to the determination of said plausible area, increasing the signal coverage area of each detected second node by a position certainty factor, wherein said position certainty factor has a magnitude that reduces in proportion to the time elapsed since the determination of the location of said respective second node.

16. The apparatus according to claim 14, further comprising means for, prior to the determination of said plausible area, reducing the signal coverage area of each identified third node by a position certainty factor, wherein said position certainty factor has a magnitude that reduces in proportion to the time elapsed since the determination of the location of said respective third node.

17. The apparatus according to claim 14, further comprising means for assigning an initial position certainty factor to said first node when said first node is located.

18. The apparatus according to claim 14, further comprising means for transmitting the location of said center to said first node.

19. The apparatus according to claim 14, further comprising means for selecting and transmitting data to said first node in dependence on the location of said center.

20. A program product comprising a computer readable medium having encoded thereon a program of instructions executable by a computer to:
receive data indicating the detection at a first node of signals transmitted from one or more second nodes, each said second node having a known location;
determine the signal coverage area of each detected second node;
identify one or more third nodes from which no signal is received at the first node, each having a known location and each having a signal coverage area coincident with said signal coverage area of one or more of said detected second nodes;
determine a plausible area for the location of said first node from the combination of the signal coverage areas for each detected second node and the exclusion of the signal coverage areas of each identified third node; and
calculate the center of said plausible area and locating said first node at said center.
